(19) United States
(12) Patent Application Publication
(10) Pub. No.: US 2026/0340090 A1
(43) Pub. Date: Oct. 29, 2026

(54) STREAMLINED SNAP-IN DEVELOPMENT WITH UNIVERSAL TOKEN MANAGEMENT

(71) Applicant: DevRev, Inc., Palo Alto, CA (US)

(72) Inventors: Kapil Garg, Bangalore (IN); Peter Marinšek, Ljubljana (SI); Raško Pavlovic, Ljubljana (SI)

(73) Assignee: DevRev, Inc., Palo Alto, CA (US)

(21) Appl. No.: 19/193,716

(22) Filed: Apr. 29, 2025

(51) Int. Cl. G06F 21/31

(52) U.S. Cl. CPC G06F 21/31

(57) ABSTRACT

A system for establishing a connection of a client system with an external system is presented. The system includes a snap-in subsystem configured to identify address details of the external system based on an authorization function, and transmit the address details to an authorization subsystem, and perform a handshake with the external system by providing an authorization code and a state of the client system, and receiving an access token, a refresh token and an expiration time from the external system.

### BACKGROUND

The present disclosure is directed to authorization frameworks in SaaS, and more particularly to an automated mechanism for requesting, receiving and managing connection authorizations from an external system.

OAuth 2.0 and personal access tokens (PATs) are conventional authorization frameworks used in SaaS world for authorization. OAuth and PAT are open-standard authorization protocol/framework that enable an accessing application to gain limited access to user accounts of another application without sharing a password with the accessing application. The accessing application is provided with an authorization token that can be used for using services of the other application on user's behalf without compromising the user's password. OAuth and PAT can be used to authorize applications, APIs, devices, and servers.

Due to the high adoption rate of the authorization frameworks like the OAuth 2.0 and PAT standard, there are many open sources, ready-to-use client libraries, like the oauth2 go package or jso javascript library. These client libraries are very sophisticated and advanced. Most of them are implemented with a great deal of flexibility and configurability to support various use cases. Many public cloud services like GitHub, AWS, or similar SaaS solutions are deeply entrenched in the fundamental infrastructure of every IT company nowadays. Most of these cloud services offer almost unlimited access to user data via publicly available API, protected by OAuth 2.0 protocol authorization.

Unfortunately, there are a lot of implementational details, i.e. differences between OAuth 2.0 protocol implementations among these public services. For example, many such services expect one to have OAuth 2.0 application installed in the “organization”. Such applications define access level to API which is segmented across security “groups”. Users would have to confirm awareness of the level of API access such an application gets after approval. Other services take a bit different approach and offer both applications and passive OAuth 2.0 applications access to the user data. The level of access to applications can vary between services.

Similarly, tokens provided for authorization require management and configurations by the user. The current token lifecycle management approach necessitates extensive configuration for each external system integration. This stems from variations in protocol implementations adopted by different systems, often requiring custom protocol exceptions and additional configuration. This approach is inherently unscalable, as users and developers need to understand and manage the complexities associated with each integration.

### BRIEF DESCRIPTION OF THE INVENTION

Aspects and advantages of the invention will be set forth in part in the following description, or may be obvious from the description, or may be learned through practice of the invention.

In accordance with an embodiment, a system for establishing a connection of a client system with an external system is presented. The system includes a snap-in subsystem configured to identify address details of the external system based on an authorization function, and transmit the address details to an authorization subsystem, and perform a handshake with the external system by providing an authorization code and a state of the client system, and receiving an access token, a refresh token and an expiration time from the external system.

In accordance with another embodiment, a method for establishing a connection of a client system with an external system is presented. The method includes identifying, by a snap-in subsystem, address details of the external system based on an authorization function, and transmit the address details to an authorization subsystem, and performing, by a snap-in subsystem, a handshake with the external system by providing a code and state of the client system, and receiving an access token, a refresh token and an expiration time from the external system.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a diagrammatic illustration of a system configured to establish a connection of a client system with an external system, in accordance with one embodiment of the present invention;

FIG. 2 is a flow diagram showing exchange of information for receiving access authorization from an external system, in accordance with one embodiment of the present invention;

FIG. 3 is a flow diagram showing exchange of information for refreshing an access token, in accordance with one embodiment of the present invention;

FIG. 4 is a flow diagram showing exchange of information for revoking a received token before disconnection, in accordance with one embodiment of the present invention; and

FIG. 5 is a block diagram of an embodiment of a computing device in which the modules of the customer support system described herein are implemented.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents. Whereas the preferred form of the invention has been shown and described herein, it should be realized that there may be many modifications, substitutions and alterations thereto.

The present systems and methods include a snap-in subsystem that is configured to connect a client system (being accessed by a user via a user's system) with an external system. The snap-in subsystem communicates with internal modules of the client system and the external system to establish a connection between the client system and the external system, refresh the connection and safely terminate the connection. The snap-in subsystem connects the client system and the external system by automatically configuring, and sending required parameters and requests for receiving access authorizations from the external system. The configurations and requirements of external systems vary from one another. The usage of the snap-in subsystem prevents a user of the client system from the effort of knowing intricate and specific configurations of different external systems required for establishing connections with the external systems. For example, when a user of a DevRev platform needs to access GitHub for receiving data, the user does not need to understand the custom protocol requirements/exceptions and configurations specific to GitHub. Hence, the present systems and methods streamline integration efforts between a client system and different external systems by minimizing the need for custom configurations and exception handling when interacting with diverse external systems.

As used herein, the term “server” means a server computer or group of computers that act to provide a service for a certain function or access to a network resource. The servers may be physical servers, hosted servers in a virtual environment, or software code running on a platform. The term “client” generally means software that communicates with a server, and “client computer” refers to any computer, embedded device, mobile device, or other system that can be used to perform the functionality described as being performed by the client computer. Specifically, client computers include devices, which can be used to display a user interface by which the functionality provided by a server can be utilized by a user. Clients may be embodied in desktop, laptop, notebook, or netbook computers, or in mobile devices, such as mobile phones, tablet computers, PDAs, smartphones, and the like. The term “application” means software used on a computer by a user, and can be applications that are targeted or supported by specific classes of machine, such as mobile application, desktop application, tablet application, enterprise application, and so on. A service is an online server or set of servers, and can refer to a web site, web application, and so on. The term “authorization” means an indication (e.g. yes/no, true/false) of whether the action is allowed, or a token that grants access or is proof of allowance of an access, and which can be provided to any system that needs proof that a given user is authorized for a particular action, or a callback to a system indicating that the user is authorized.

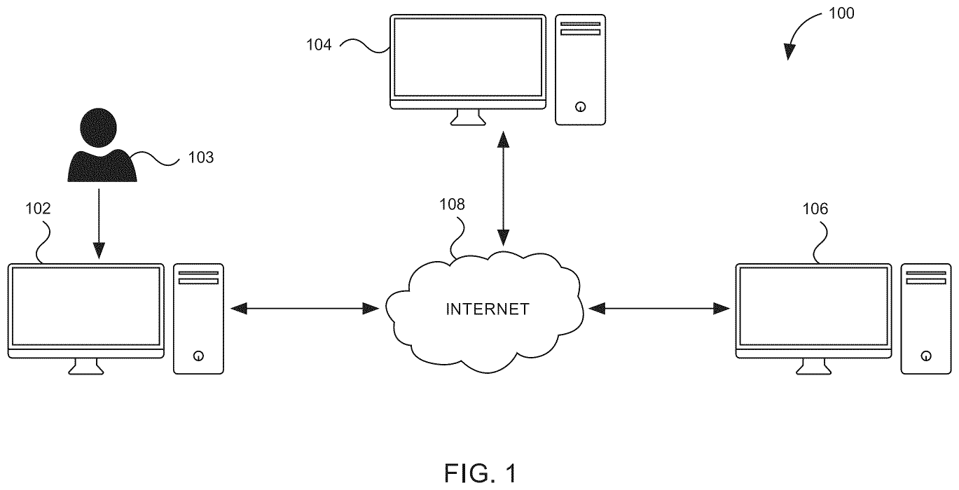

FIG. 1 is a diagrammatic illustration of a system 100 configured to establish a connection of a client system 104 with an external system 106, in accordance with one embodiment of the present invention. The system 100 includes a user system 102 used by a user 103 to perform various functions including access services from one or more servers including the client system 104 and the external system 106. The user system 102, for example, may be embodied in a workstation computer or it may be a computing device such as a notebook computer, personal digital assistant, or the like. The client computer 104 may also be embodied within a mobile communications device (e.g., smartphone, mobile phone, tablet device, etc.), game console, media playback unit, or similar computing device that provides access to Internet network 108. In one embodiment, the client computer 104 may also operate as a server providing services to the user system 102.

In one embodiment, the user 103 is accessing the client system 104 via the user system 102. For example, the user 103 may be accessing the client system 104 via the internet 108 to develop a software or an application on the client system 104. The user 103 needs access of the external system 106 for accessing services offered by the external system 106. For example, the external system 106 may be offering services including team management, business management, software development, project management, data, and the like. The user 103 accesses the external system 106 without sharing the authorization details with the client system 104. For example, the user 103 may access the client system 104 for developing a software on the client system 104, and may want to access data offered by the external system 106 or data that belongs to the user 103. In the presently contemplated configuration, the user 103 may authorize the external system 106 to share the data corresponding to user's account with the client system 104, without the need of sharing authorization details with the client system 104. Additionally, for connecting to the external system 106, the user 103 does not need to perform manual configurations as per the specific requirements of the external system 106. Different external systems have different configuration requirements for connecting. The client system 104 is configured to connect the client system 104 to the external system 106 without the user 103 to know the nitty-gritties and variations in configurations for connecting with external systems, such as the external system 106.

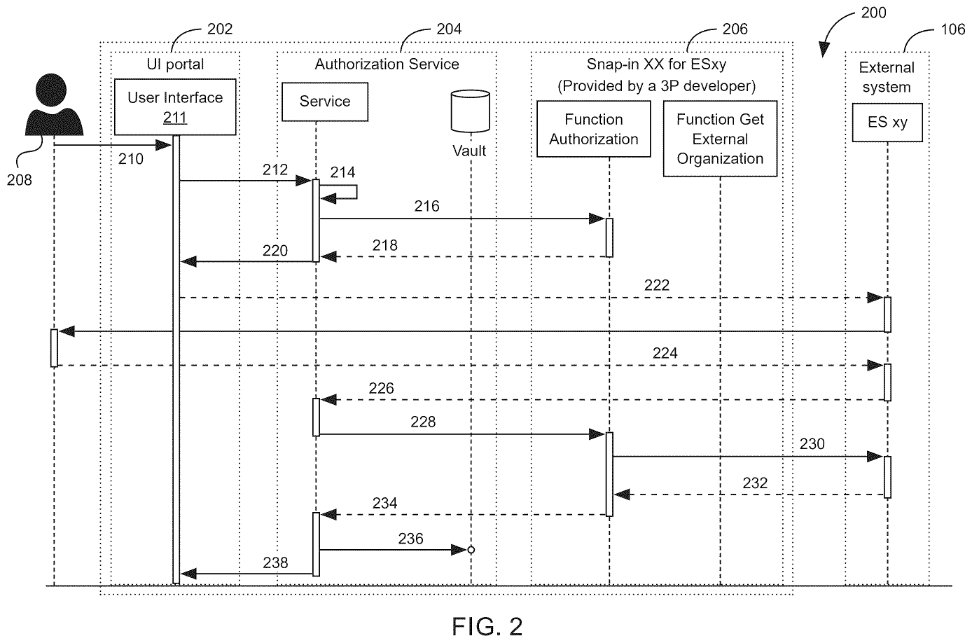

In the presently contemplated configuration, the client system 104 includes a snap-in subsystem (not shown) configured to identify address details of the external system 106 based on an authorization function, and transmits the address details to the authorization subsystem (not shown). The snap-in subsystem additionally performs a handshake with the external system 106 by providing a code and state of the client system 104, and receiving an access token, a refresh token and an expiration time from the external system 106. The details of establishing the connection with the external system 106 shall be explained in greater detail with reference to FIG. 2.

FIG. 2 is a flow diagram 200 showing exchange of information for receiving access authorization from the external system 106, in accordance with one embodiment of the present invention. As shown, the client system 104, referred to in FIG. 1, includes a web application 202, an authorization subsystem 204 and a snap-in subsystem 206. The authorization subsystem 204 and the snap-in subsystem 206, for example may be software modules located on the same or different client computing devices. The web application 202 is communicatively coupled to the authorization subsystem 204, and the authorization subsystem 204 is operatively coupled to the snap-in subsystem 206. In other words, the web application 202 sends and receives messages and/or tasks from the authorization subsystem 204, and the authorization subsystem 204 sends and receives messages from the snap-in subsystem 206.

A user 208 logs into the web application 202 of the client system 104, and accesses a user interface 211 of the web application 202. At step 210, the user 208 enters a request, into the web application 202, for connecting to the external system 106 for accessing user's services/data in the external system 106. At step 212, the user interface 211 of the web application 202 sends the request for connection to the authorization subsystem 204. The authorization subsystem 204 invokes for an authorization function registered in the snap-in subsystem 206, at step 214. The authorization function, for example, is a lambda function that a snap-in developer provides (e.g. as JS code). This function returns URL of the external system 106, together with the OAuth2 app information: client ID and secret.

At step 216, the authorization subsystem 204 executes the authorization function to retrieve the address details (URL) of the external system 106. Particularly, the authorization subsystem 204 sends a request to retrieve uniform resource locator (URL) for initiating authorization process with the external system 106. The snap-in subsystem 206 identifies the address details, and at step 218, the snap-in subsystem 206 transmits the address details to the authorization subsystem 204. At step 220, the authorization subsystem 204 sends the address details, such as the URL to the web application 202. At step 220, the authorization subsystem 204 additionally sends state, redirect URL in response to query parameters of the URL. At step 220, the web application receives the address details (URL), state, redirect URL from the authorization subsystem 204. The URL also includes address details of the client system 104 (particularly the authorization subsystem 204) to enable the external system 106 to send messages/instructions/information to the authorization subsystem 204. At step 222, the web application 202 redirects the user 208, using the URL, to the external system 106 that opens a consent webpage. The consent webpage requires the user 208 to input respective authorization details. At step 224, the user 208 inputs respective authorization details (user id, password etc.), and agrees to a connection between the client system 104 and the external system 106 to receive services/data corresponding to the user 208 by the client system 104.

At step 226, the external system 106 sends an authorization code and state of the potential connection to the authorization subsystem 204. The authorization code is a short, temporary identifier that can be used by the client system 104 to get an access token from the external system 106. The authorization code represents the user's 208 consent to grant the client system 104 access to protected data/services in the external system 106. The ‘state’ parameter is used to associate the user 208 with an authorization flow. This makes the authorization flow more secure, as the authorization flow cannot be hijacked to associate the user's account with another user's token.

At step 226, the code and state are received by the authorization subsystem 204 from the external system 106, and at step 228 the authorization subsystem 204 sends the code to the snap-in subsystem 206, and requests the snap-in subsystem 206 to get an access token from the external system 106. At step 230, the snap-in subsystem 206 sends parameters along with the code, client id and client secret of the client system 104 to the external system 106, and sends a HTTP POST request to the external system 106.

At step 232, the snap-in subsystem 206 receives the access token, a refresh token and an expiration time from the external system 106. The access token, for example is a digital credential that grants the client system 104 access to protected resources (service, data etc.) without needing to repeatedly authenticate with the external system 106. The expiration time is a time period for which the access token is valid. The refresh token is a new token that is used to renew the access token when the access token expires.

At step 234, the snap-in subsystem 206 sends the access token, the refresh token and the expiration time to the authorization subsystem 204. At step 236, the authorization subsystem 204 securely stores the access token, the refresh token and the expiration time in respective storage device, such as a vault. At step 238, the authorization subsystem 204 creates a connection identification number/name for the connection between the client system 104 and the external system 106, and sends the connection identification number/name to the web application 202. The access token may be leveraged by the client system 104 to access data or services corresponding to the user 208 from the external system 106.

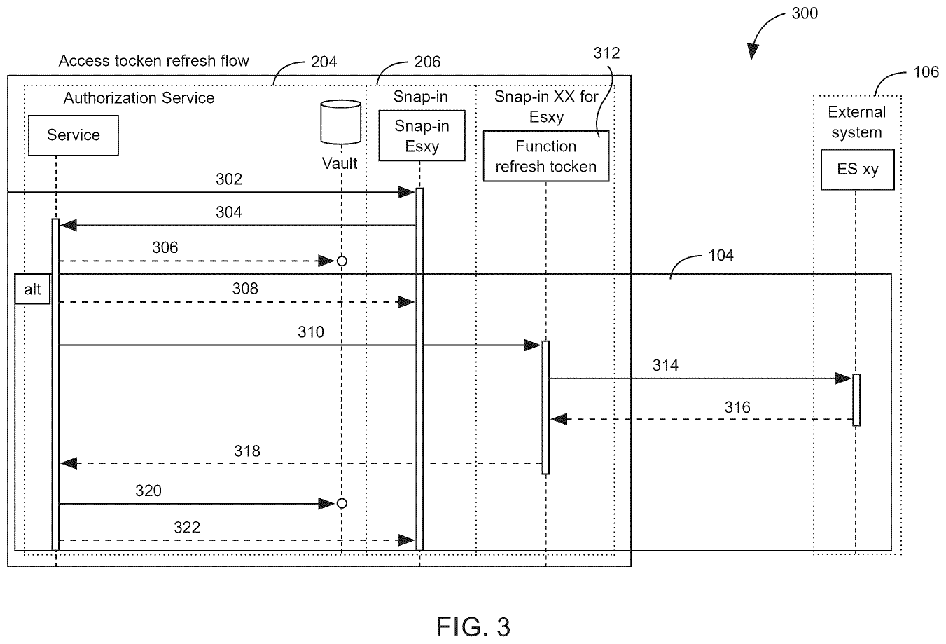

FIG. 3 is a flow diagram 300 showing exchange of information for refreshing an access token, in accordance with one embodiment of the present invention. As shown in FIG. 3, the snap-in subsystem 206 communicates with the authorization subsystem 204 and the external system 106 to refresh the access token. At block 302, an event is triggered, and the authorization subsystem 204 informs the snap-in subsystem 206 about the trigger of the event. The event is triggered as the client system 104 or the user 208 needs to access data or services from the external system 106. The snap-in subsystem 206 needs access token from the authorization subsystem 204 for enabling the client system 104 or the user 208 to access the data or services from the external system 106. On receipt of the information of the event trigger, at step 304, the snap-in subsystem 206 requests the access token (referred to in FIG. 2) from the authorization subsystem 204. At step 306, the authorization subsystem 204 reads the access token along with expiration time to determine whether the access token has expired. When the authorization subsystem 204 determines that the access token has not expired, at step 308, the authorization subsystem 204 sends the access token to the snap-in subsystem 206. When the authorization subsystem 204 determines that the access token has expired, at step 310, the authorization subsystem 204 sends a token refresh request to the refresh token snap-in module 312. In one embodiment, the request, for example, is received by the refresh token snap-in module 312 of the snap-in subsystem 206. Post receiving the access token, at step 314, the snap-in subsystem 206 sends a HTTP POST request to the external system 106 by transmitting the access token to the external system 106. The HTTP POST includes the access token along with one or more parameters including type of grant, refresh token, client ID and client Secret. In one embodiment, the external system 106 may not send the refresh token to the snap-in subsystem 312, as the refresh token may not be required by the external system 106 for sharing data/services. In response to the receipt of the access token, at step 318, the external system 106 sends a new access token, a refresh token (optional) and a new expiration time to the snap-in subsystem 206. At step 316, the refresh token snap-in module 312 receives the new access token, refresh token and expiration time from the external system 106, and the access token is refreshed in the external system 106. Post receiving the access token and the refresh token, the connection (described in FIG. 2) between the client system 104 and the external system 106 continues. At step 318, the refresh token snap-in module 312 sends the new access token, refresh token and expiration time to the authorization subsystem 204. At step 320, the authorization subsystem 204 updates the new access token, the refresh token and the new expiration time in the authorization subsystem 204. At step 322, the authorization subsystem 204 sends the new access token to the snap-in subsystem 206 for exchanging the same with the external system 106. The new access token may be exchanged to continue with the connection and gain access to the protected resources of the external system 106 by the client system 104. For example, the client system 104 and/or the snap-in subsystem 206 may leverage the new access token to access data or services corresponding to the user (referred to in FIG. 2) from the external system 106.

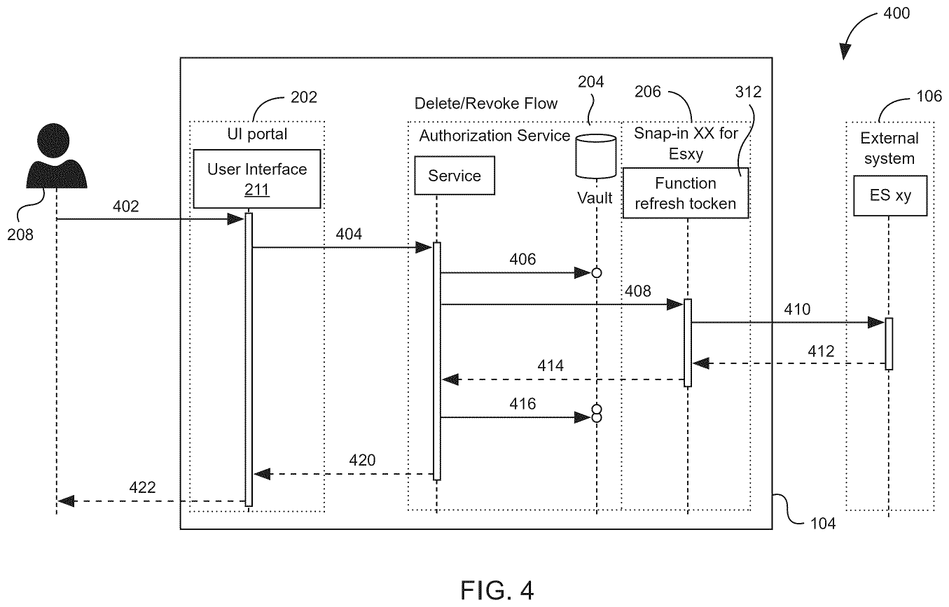

FIG. 4 is a flow diagram 400 showing exchange of information for revoking a received token before disconnection, in accordance with one embodiment of the present invention. The snap-in subsystem 206 is configured to revoke the access token, the new access token or the refresh token (referred to in FIG. 2 and FIG. 3) before the connection is deleted between the client system 104 and the external system 106. At step 402, a request is sent by the user 208 to delete or disconnect an existing connection between the client system 104 and the external system 106. For example, the user 208 may send the request from the user system 102 (see FIG. 1) to the client system 104. Particularly, the user 208 may access the user interface 211 of the web application 202, using the user system 102, to send a request for disconnection between the client system 104 and the external system 106.

At block 404, the web application 202 sends a connection deletion request to the authorization subsystem 204. At step 406, the authorization subsystem 204 retrieves the access token (referred to in FIG. 2 and FIG. 3) from a respective storage device. Thereafter, at step 408, the authorization subsystem 204 sends the retrieved access token to the snap-in subsystem 206, and requests the snap-in subsystem 206 to revoke the access token from the external system 106. At step 410, the snap-in subsystem 206 sends a token revocation request to a designated application interface of the external system 106. In one embodiment, the snap-in subsystem 206 sends the access token or the new access token to the external system 106 for identification of the connection by the external system 106. At step 412, the snap-in subsystem 206 receives a confirmation on revocation of the access token from the external system 106.

At step 414, snap-in subsystem 206 confirms to the authorization subsystem 204 about the revocation of the access token or the new access token by the external system 106. At step 416, the authorization subsystem 204 deletes the access token, the new access token or the refresh token from the respective data repository. Additionally, at step 418, the authorization subsystem 204 deletes the connection identification or any other associated information in the respective data repository. Furthermore, at step 420, authorization subsystem 204 informs the web application 202 about deletion of the connection with the external system 106. Also, at step 422, the web application 202 informs the user 208 about the deletion of the connection.

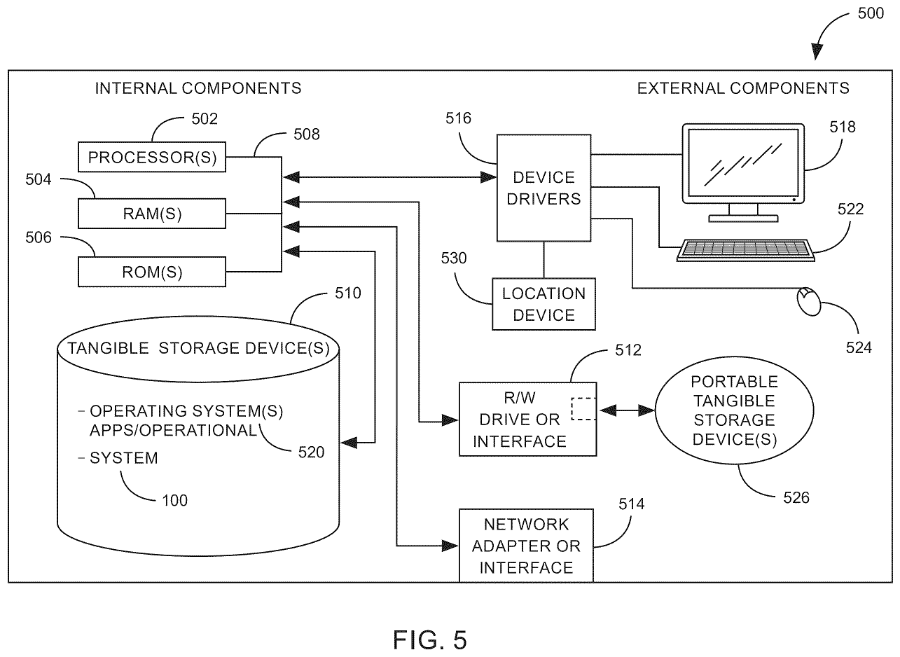

The techniques and systems described herein is implemented using a computing device such as computing device 500 is described below in FIG. 5. The computing device 500 includes one or more processor(s) 502, one or more computer-readable RAMs 504 and one or more computer-readable ROMs 506 on one or more buses 508. Further, computing device 500 includes a tangible storage device 510 that includes operating system 520. The operating systems 520 are executed by the one or more processor(s) 502 via one or more respective RAMs 504 (which typically include cache memory). The execution of the operating systems 520 by the one or more processor(s) configures the one or more processor(s) as a special purpose processor configured to carry out upgrade operations described above.

Examples of the tangible storage device include semiconductor storage devices such as ROM, EPROM, flash memory or any other computer-readable tangible storage device that may store a computer program and digital information.

Computing device 500 also includes a R/W drive or interface 512 to read from and write to one or more portable computer-readable tangible storage devices 96 such as a CD-ROM, DVD, memory stick or semiconductor storage device. Further, network adapters or interfaces 514 such as a TCP/IP adapter cards, wireless Wi-Fi interface cards, or 3G or 4G wireless interface cards or other wired or wireless communication links are also included in computing device.

Computing device 500 further includes device drivers 516 to interface with input and output devices. The input and output devices may include a computer display monitor 518, a keyboard 522, a keypad, a touch screen, a computer mouse 524, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

We claim:

1. A system for establishing a connection of a client system with an external system, comprising:
a snap-in subsystem configured to:
identify address details of the external system based on an authorization function, and transmit the address details to an authorization subsystem; and
send a POST request to the external system by providing an authorization code and a state of the client system, and receiving an access token and an expiration time from the external system.

2. The system as claimed in claim 1, wherein the client system comprises a web application, the authorization subsystem and the snap-in subsystem, wherein the web application is operationally coupled to the authorization subsystem and the authorization subsystem is operationally coupled to the snap-in subsystem.

3. The system as claimed in claim 1, wherein the snap-in subsystem is configured to send the POST request to the external system by exchanging a plurality of parameters with the external system, wherein the plurality of parameters comprises identification details of the client system, state of the system, scope of access and permissions required by the client system, a uniform resource locator, authentication code, or combinations thereof.

4. The system as claimed in claim 1, wherein the snap-in subsystem is configured to leverage the access token to access data or services corresponding to a user from the external system.

5. The system as claimed in claim 4, wherein the snap-in subsystem is further configured to refresh the connection by:
receiving a request for refreshing the access token from an authorization subsystem of the client system;
retrieving the access token received from the external system;
sending the POST request to the external system by transmitting the access token, and
receiving a new access token from the external system,
wherein the new access token continues access of data or services corresponding to the user from the external system.

6. The system as claimed in claim 1, wherein the snap-in subsystem is further configured to revoke the connection by:
sending a token revocation request to a designated application interface of the external system; and
receiving a confirmation on revocation of the access token from the external system.

7. The system as claimed in claim 4, wherein the snap-in subsystem is configured to revoke the access token before the connection is deleted between the client system and the external system.

8. The system as claimed in claim 5, wherein the client system comprises a web application operationally coupled to the authorization subsystem, wherein the web application is configured to:
receive a connection request, from the user, for establishing a connection between the client system and the external system;
transmit the connection request, with details of the external system, to the authorization subsystem;
receive address details from the authorization subsystem; and
enable the user, based on the address details, to enter respective authorization details to enable the client system to access the external system.

9. The system as claimed in claim 7, wherein the authorization subsystem is configured to:
receive the connection request from a user system of the user;
identify an authorization function based on the connection request;
send a request for the address details of the external system and the access token to the snap-in subsystem; and
receive the access token, the refresh token and the expiration time from the snap-in subsystem.

10. A method for establishing a connection of a client system with an external system by:
identifying, by a snap-in subsystem, address details of the external system based on an authorization function, and transmit the address details to an authorization subsystem; and
sending a POST request to the external system by providing a code and state of the client system, and receiving an access token, a refresh token and an expiration time from the external system.

11. The method as claimed in claim 10, wherein the access token is leveraged to access data or services corresponding to a user from the external system.

12. The method as claimed in claim 10, further comprising refreshing the connection by:
receiving, by the snap-in subsystem, a request for refreshing the access token from an authorization subsystem of the client system;
retrieving, by the snap-in subsystem, the access token received from the external system;
executing, by the snap-in subsystem, a new handshake process with the external system by transmitting the access token, and
receiving, by the snap-in subsystem, a new access token from the external system,
wherein the new access token continues the connection between the client system and the external system.

13. The method as claimed in claim 10, further comprising:
sending, by the snap-in subsystem, a token revocation request to a designated application interface of the external system; and
receiving, by the snap-in subsystem, a confirmation on revocation of the token from the external system.

14. The method as claimed in claim 13, wherein the access token is revoked, by the snap-in subsystem, before the connection is deleted between the client system and the external system.

15. The method as claimed in claim 10, further comprising:
receiving, by a user interface of the client system, a connection request for establishing a connection between the external system and the client system from a user;
transmitting, by the user interface, the connection request, with the details of the external system, to an authorization subsystem;
receiving, by the user interface, address details from the authorization subsystem; and
enabling the user, based on the address details, to enter respective details for authorization to the external system.

16. The method as claimed in claim 15, further comprising:
receiving, by the authorization subsystem, the connection request from the user interface;
determine, by the authorization subsystem, an authorization function based on the connection request;
sending, by the authorization subsystem, a request for the address details of the external system and the access token to the snap-in subsystem; and
receiving, by the authorization subsystem, the access token, the refresh token and the expiration time from the snap-in subsystem.
